(19) United States
(12) Patent Application Publication
(10) Pub. No.: US 2008/0297694 A1
(43) Pub. Date: Dec. 4, 2008

(54) BACKLIGHT MODULE OF REDUCING LIGHT LEAKAGE FOR USE IN A LIQUID CRYSTAL DISPLAY DEVICE

(75) Inventors: Shin-li Chen, Hsin-Chu City (TW); Chao-chih Wei, Hsin-Chu City (TW); An-pang Lin, Hsin-Chu City (TW); Ching-Kun Lai, Hsin-Chu City (TW)

Correspondence Address: MADSON & AUSTIN, 15 WEST SOUTH TEMPLE, SUITE 900, SALT LAKE CITY, UT, 84101, US

(73) Assignee: AU Optronics Corp., Hsin-Chu (TW)

(21) Appl. No.: 11/854,712

(22) Filed: Sep. 13, 2007

(30) Foreign Application Priority Data
May 30, 2007 (TW) 096119403

(51) Int. Cl. F21V 7/04; G02F 1/1335

(52) U.S. Cl. 349/65; 362/632

(57) ABSTRACT

A backlight module includes a frame, a plurality of light tubes disposed on the frame, an optical sheet, a first light tube fixing component disposed on a side of the frame, and a second light tube fixing component disposed on a bottom surface of the frame. The frame includes a plurality of holes defined on a bottom surface of the frame. The first light tube fixing component is used for fixing the plurality of light tubes on the frame. The first light tube fixing component includes light proof member and a light reflective component. The light proof member is used for blocking light from the plurality of light tubes. The light reflective component is used for reflecting light from the plurality of light tubes toward the optical sheet. The light proof member and the light reflective component are integrally formed. The second light tube includes a substrate plate, a plurality of supporting holders disposed on a first side of the substrate plate, and a plurality of engaging portions disposed on a second side opposite to the first side. Each engaging portion is made of light proof materials and corresponds to one of the plurality of holes. The substrate plate, the plurality of supporting holders, and the plurality of engaging portions are integrally formed.

### BACKGROUND OF THE INVENTION

1. Field of the Invention

The present invention relates to a backlight module for use in a liquid crystal display device, and more particularly, to a backlight module capable of reducing light leakage for use in a liquid crystal display

2. Description of Prior Art

With a rapid development of various display technologies, novel and colorful monitors with high definition, e.g., liquid crystal displays (LCDs), are indispensable components used in various electronic products such as mobile phones, personal digital assistants, digital cameras, desktop computers, and notebook computers.

The liquid crystal does not emit light itself, and thus a backlight module is required to provide a well-distributed light with sufficient brightness for a liquid crystal to display images normally. FIG. 1 depicts an exploded view of a backlight module 10 according to prior art. A typical backlight module 10 includes a light guiding plate 16, a plurality of light tubes 18, and a plurality of optical sheets. An optical sheet includes a diffusion plate 4, a prism sheet 6, and a polarizing film 8, etc. Generally, the light tubes 18 are cold cathode fluorescent light tubes, which are configured within the backlight module 10 in a parallel manner. The light guiding plate 16, through which the light emitted from the light tubes 18 passes, guides the direction of light to control the brightness uniformity. Then, the light emitted from the light guiding plate 16 passes through the diffusion plate 4, of which particles may result in an optical diffusion, so as to provide an uniform area light. The prism sheet 6 enhances brightness depending upon the refraction and reflection of light, thereby increasing the effectiveness of using the light emitted from the diffusion plate 4. The polarizing film 8 converts the light into a polarized light.

FIG. 2 depicts a lamp holder as shown in FIG. 1, and FIG. 3 depicts a cross-sectional view of a light guiding plate shown in FIG. 1 along a line 1-1′. As shown in FIG. 1, the bottom surface 121 of the frame 12 of the backlight module 10 is used for configuring a plurality of light tubes 18, such as cold cathode fluorescent light tubes. Lamp holders 14 are assembled at two sides of the frame 12. The lamp holder 14 includes a Light tube fixing component 141 and a plurality of indentations 142 thereon. The plurality of indentations 142 are used for positioning and fixing the plurality of light tubes 18 onto the bottom surface 121 of the frame 12. In addition, the lamp holder 14 also includes a groove 146 for embedding the light guiding plate 16. Finally, all optical sheets are disposed over the lamp holder 14. Conventionally, white reflective materials are applied to the whole of the lamp holder 14, such that the light emitted from the light tube 18 concentrates onto the light guiding plate 16 after reflection. In such case, when a light tube 18 emits light, the Light tube fixing component 141 of white reflective materials may guide the reflected light in the direction of the light guiding plate 16, so as to effectively utilize light.

FIG. 4 shows a schematic diagram of a backlight module 10 generating light leakage according to the prior art. A condensing reflection occurs at the groove 146 of the lamp holder 14 when the light passing through the diffusion place 4. In such case, bright zones are generated on the two sides 104 of the display area 102 of the backlight module 10, that is, the problem of light leakage at edge side of the backlight module 10 occurs.

FIGS. 5A and 5B depict a lamp support 15 shown in FIG. 1, and FIG. 6 shows a frame 12 in a view along a direction of arrow A according to FIG. 1. The backlight module 10 also includes a plurality of lamp supports 15, each lamp support 15 having a substrate plate 151, a plurality of supporting holders 152, a plurality of engaging portions 154 and a plurality of protrusion components 156. Each supporting holder 152 is disposed on the first side 1511 of the substrate plate 151 for fixing a corresponding light tube 18. A plurality of engaging portions 154 are disposed on the second side 1512 of the substrate plate 151, opposite to the first side 1511. A plurality of holes 122 are formed on the frame 12, and each engaging portion 154 is embedded into one of the holes 122 correspondingly. When the light guiding plate 16 and the diffusion plate 4 are fixed onto the groove 146 of the lamp holder 14, the region between the light guiding plate 16 and the diffusion place 4 may descend due to influence of gravity. Thus, the protrusion components 156 of the lamp support 15 are used for supporting the light guiding plate 16 and the diffusion plate 4 to be disposed horizontally. However, conventionally, the whole lamp support 15 is made of white reflective materials, and then the light generated by the light sources 18 may emit from the holes 122 formed on the frame 12, thereby resulting in light leakage at back side of the backlight module 10 occurs.

Therefore, a common objective for producers is to develop an improved backlight module capable of reducing light leakage at edge sides and back side of the backlight module.

### SUMMARY OF THE INVENTION

It is therefore an object of the present invention is to provide an improved backlight module of reducing polarized light leakage and imperfection of light leakage, so as to resolve the above-mentioned problems.

Briefly summarized, a backlight module comprises a frame, a plurality of light tubes disposed on the frame, an optical sheet a first light tube fixing component disposed on a side of the frame, and a second light tube fixing component disposed on a bottom surface of the frame. The frame comprises a plurality of holes defined on a bottom surface of the frame. The plurality of light tubes are used for generating light. The first light tube fixing component is used for fixing the plurality of light tubes on the frame. The first light tube fixing component comprises light proof member and a light reflective component. The light proof member is used for blocking light from the plurality of light tubes. The light reflective component is used for reflecting light from the plurality of light tubes toward the optical sheet. The light proof member and the light reflective component are integrally formed as one piece. The second light tube comprises a substrate plate, a plurality of supporting holders disposed on a first side of the substrate plate, and a plurality of engaging portions disposed on a second side opposite to the first side. Each engaging portion is made of light proof materials and corresponds to one of the plurality of holes. The substrate plate, the plurality of supporting holders, and the plurality of engaging portions are integrally formed.

According to the present invention, a backlight module comprises a frame, a plurality of light tubes for generating light, an optical sheet, and a lamp holder disposed on a side of the frame. The lamp holder is used for fixing the plurality of light tubes on the frame The lamp holder comprises a light reflective component defining a plurality of indentations, the plurality of indentations and a light proof member. The light reflective component is used for reflecting light from the plurality of light tubes toward the optical sheet. The optical sheet is embedded with a groove formed between the light proof member and the light reflective component. The light proof member and the light reflective component are integrally formed as one piece.

According to the present invention, a backlight module comprises a frame defining a plurality of holes, a plurality of light tubes for generating light, an optical sheet, and a lamp support disposed on a bottom surface of the frame. The lamp support comprises a substrate plate, a plurality of supporting holders disposed on a first side of the substrate plate for fixing the plurality of light tubes, and a plurality of engaging portions disposed on a second side opposite to the first side. Each engaging portion is made of light proof materials and corresponding to one of the plurality of holes. The substrate plate, the plurality of supporting holders, and the plurality of engaging portions are integrally formed.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 depicts an exploded view of a backlight module according to the prior art.

FIG. 2 depicts a lamp holder as shown in FIG. 1.

FIG. 3 depicts a cross-sectional view of a light guiding plate shown in FIG. 1 along a line 1-1′.

FIG. 4 shows a schematic diagram of a backlight module generating light leakage according to the prior art.

FIGS. 5A and 5B depict a lamp support shown in FIG. 1.

FIG. 6 shows a frame in a view along a direction of arrow A according to FIG. 1.

FIG. 7 depicts an exploded view of a backlight module according to the present invention.

FIG. 8 depicts a lamp holder shown in FIG. 7.

FIG. 9 depicts a cross-sectional view of a light guiding plate shown in FIG. 7 along a line of 7-7′.

FIGS. 10A to 10C depict various embodiments of the fixation of a light reflective component and a light proof member onto each other according to the present invention.

FIG. 11A depicts a lamp support shown in FIG. 7.

FIG. 11B and FIG. 11C are the bottom view and the side view of a lamp support shown in FIG. 11A, respectively.

FIG. 12 depicts a frame from a view of the direction of arrow B according to FIG. 7.

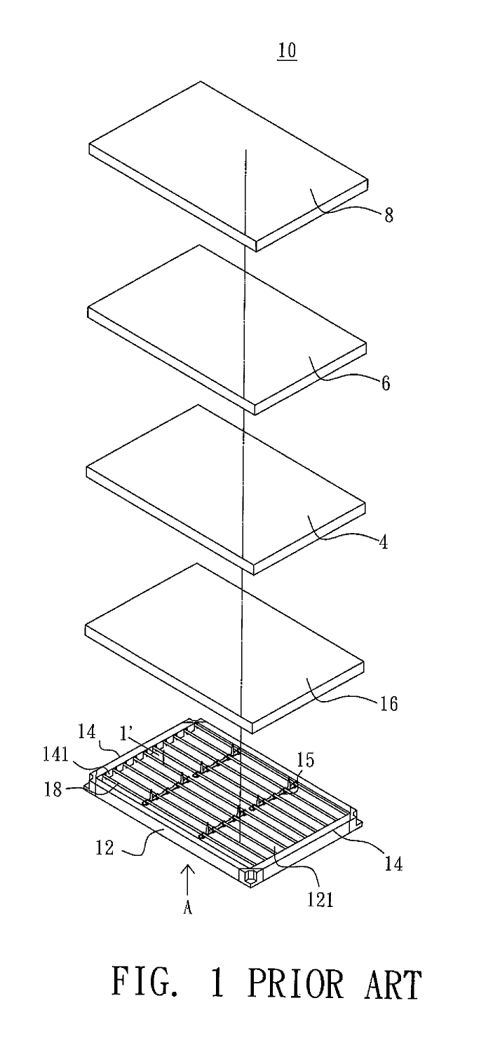

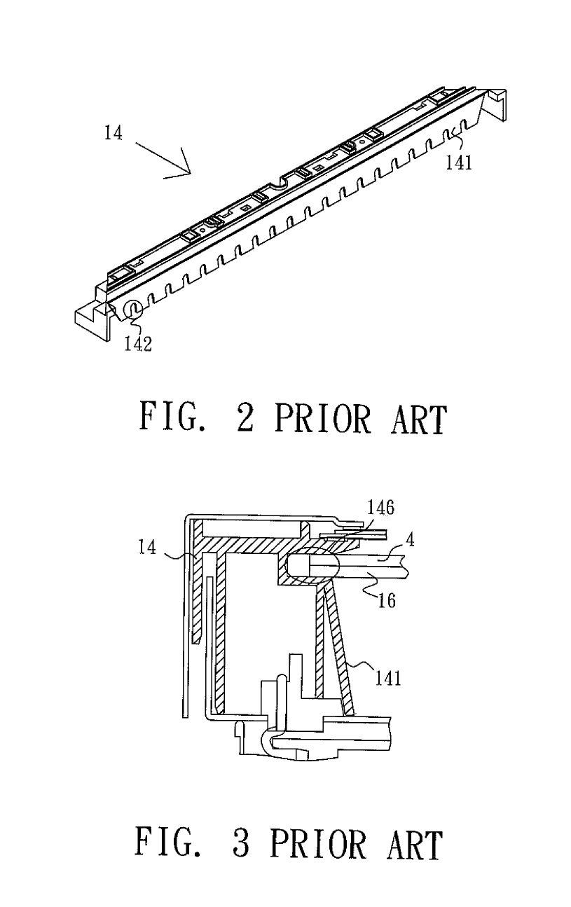

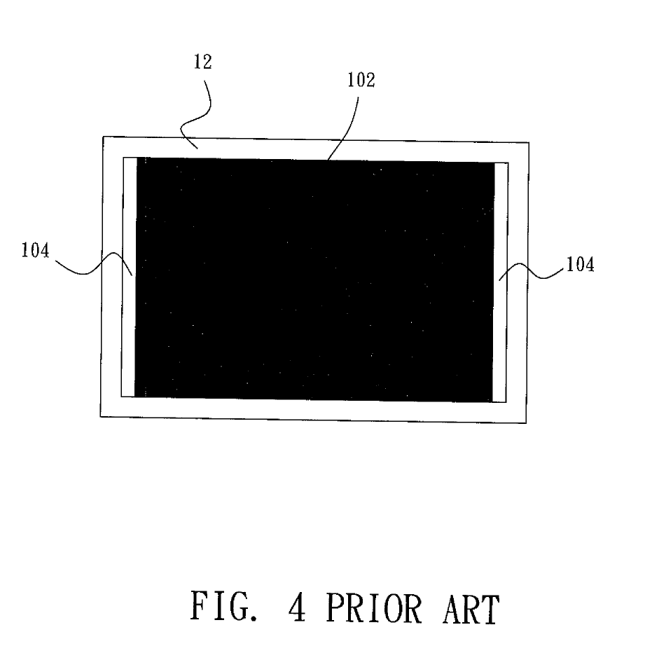

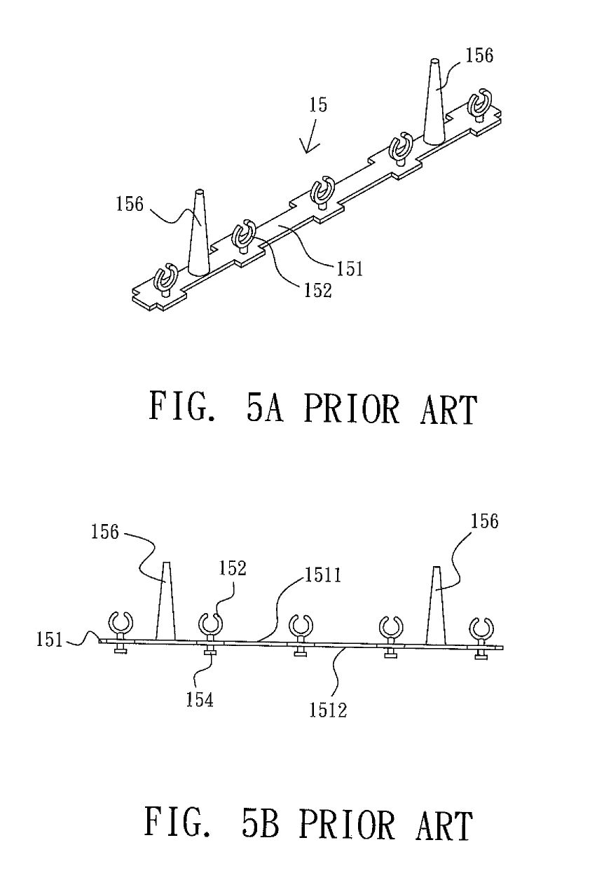

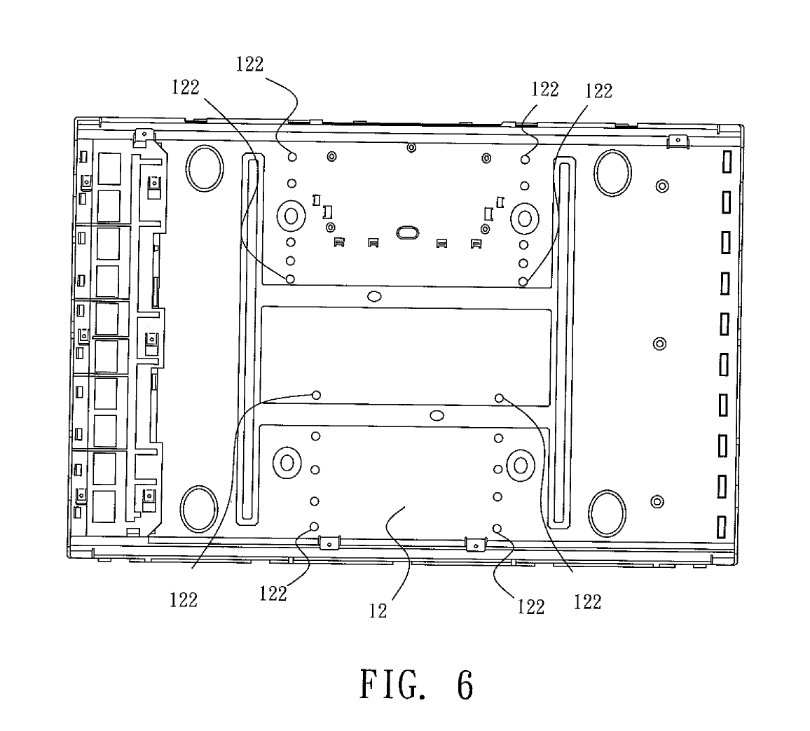

### DETAILED DESCRIPTION OF THE INVENTION

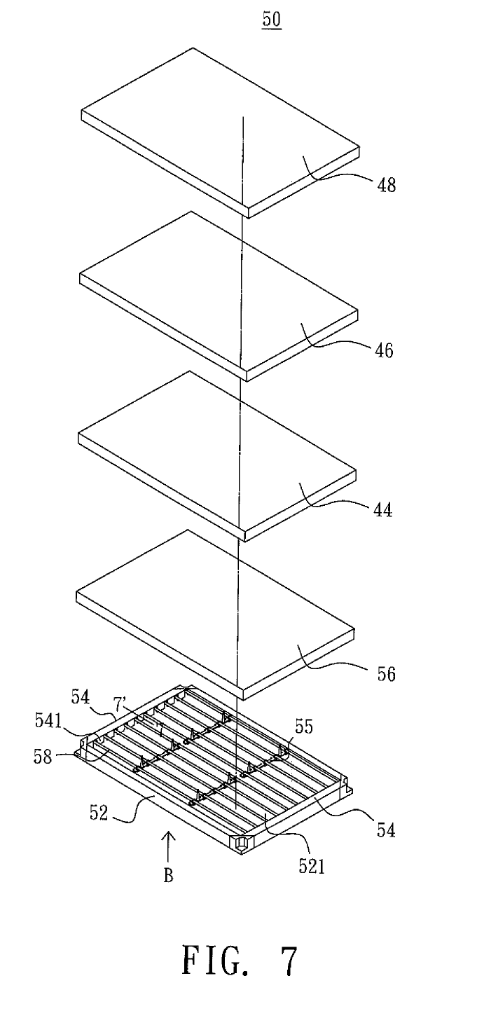

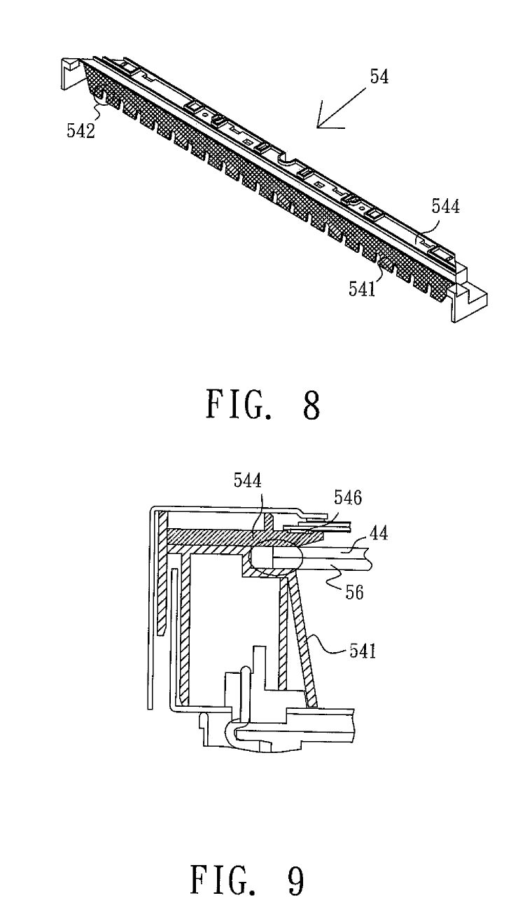

Referring to FIG. 7 to FIG. 9, FIG. 7 depicts an exploded view of a backlight module 50 according to the present invention, FIG. 8 depicts a lamp holder shown in FIG. 7, and FIG. 9 depicts a cross-sectional view of a light guiding plate shown in FIG. 7 along a line of 7-7′. In this embodiment, the backlight module 50 comprises a light guiding plate 56, a plurality of light tubes 58 and a plurality of optical sheets. Each optical sheet may be a diffusion plate 44, a prism sheet 46 and a polarizing film 48, etc. In general, the light tubes 58 are cold cathode fluorescent light tubes, which are configured within the backlight module 50 in a parallel manner. The light guiding plate 56, through which the light emitted from the light tube 58 passes, may guide the direction of light to control the brightness uniformity. Then, the light emitted from the light guiding plate 56 passes through the diffusion plate 44, of which the granules may result in an optical diffusion, so as to provide an uniform area light. The prism sheet 46 enhances brightness depending upon the refraction and reflection of light, thereby increasing the effectiveness of using the light emitted from the diffusion plate 44. The polarizing film 48 converts the light into a useful polarized light for enhancing brightness.

As illustrated in FIG. 7, the bottom surface 521 of the frame 52 of the backlight module 50 is used for the configuration of light tubes 58, such as cold cathode fluorescent lamps. Light tube fixing components, namely, lamp holders 54 and lamp supports 55 are positioned on the two sides and the bottom surface 521 of the frame 52, respectively. The lamp holder 54 comprises a light reflective component 541 and a light proof member 544, which are molded by using co-injection molding. A plurality of indentations 542 formed on the light reflective component 541 are used for fixing the plurality of light tubes 58 onto the bottom surface 521 of the frame 52. Preferably, the light reflective component 541 may be made of white reflective materials or other materials with high reflection coefficient, such that the light emitted from the light tubes 58 may be reflected to the light guiding plate 56. The light proof member 544 is made of a black light proof material. A groove 546 is formed between the light reflective component 541 and the light proof member 544. The light proof member 544 may press the edges of the light guiding plate 56 and the diffusion plate 44. In other words, the groove 546 is used for embedding the optical sheets.

The light reflective component 541 of the lamp holder 54 is made of white reflective materials, and thus the light emitted from the light tube 58 may be concentrated onto the light guiding plate 56 after reflection. However, the light proof member 544 may obstruct light, thereby covering the spot light generated at the groove 546. In such case, the bright zone does not occur at the two sides of the image displayed by the backlight module 50, so as to reduce light leakage at edge sides of the backlight module.

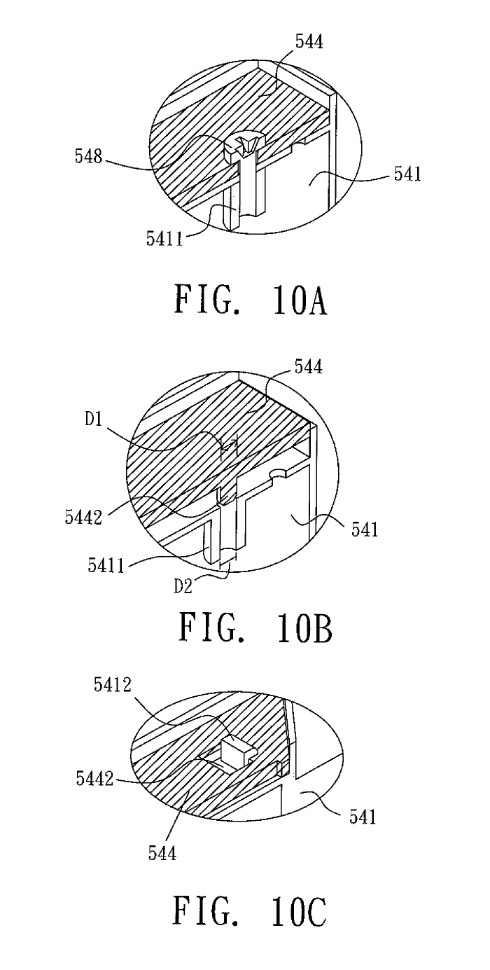

FIGS. 10A to 10C depict various embodiments of the fixation of a light reflective component 541 and a light proof member 544 onto each other according to the present invention. As shown in the embodiment according to FIG. 10A, a fixed component 548 (for example, a screw), is fixed into the slot 5411 of the light reflective component 541, after passing through the openings formed on the light proof member 544. As illustrated in the embodiment according to FIG. 10B, the light proof member 544 comprises a protrusion pillar 5442, whose diameter D1 is a little bit larger than the diameter D2 of the slot 5411 of the light reflective component 541. In assembling, an exerted force may enable the protrusion pillar 5442 to be embedded into the slot 5411 of the light reflective component 541. As illustrated in the embodiment according to FIG. 10C, the light proof member 544 has an opening 5441, and the light reflective component 541 has a hook 5412. In assembling, the hook 5412 may pass through the opening 5441 formed on the light proof member 544, such that the light proof member 544 is buttoned up onto the light reflective component 541.

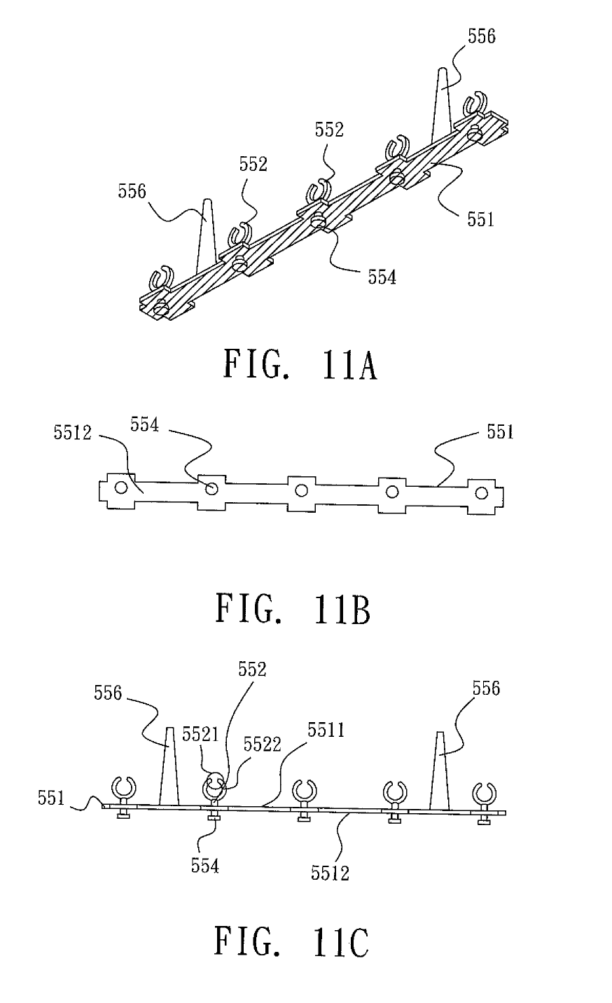

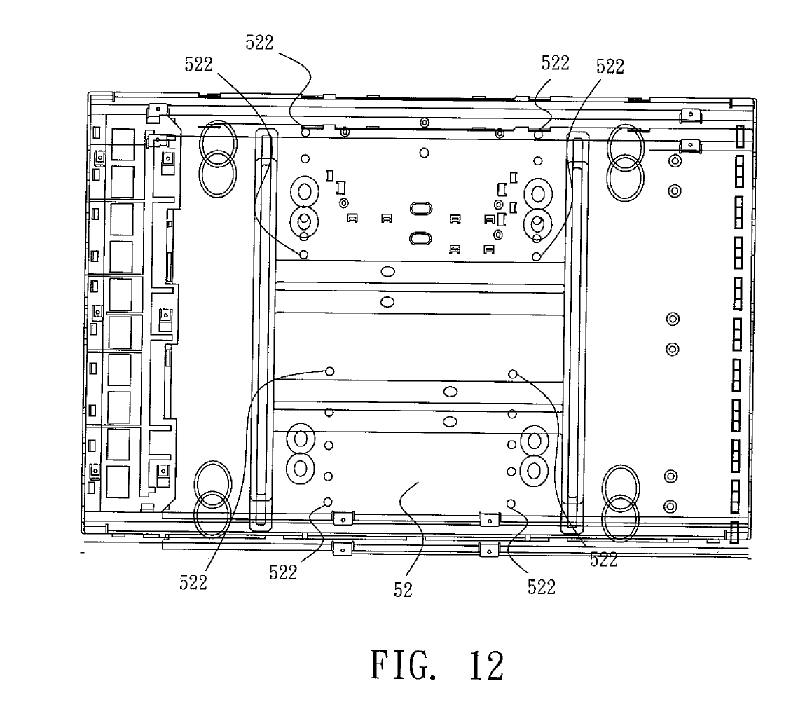

Referring to FIGS. 7, 11A, 11B, 11C and 12, FIG. 11A depicts a lamp support 55 shown in FIG. 7, FIG. 11B and FIG. 11C are the bottom view and the side view of a lamp support 55 shown in FIG. 11A, respectively. FIG. 12 depicts a frame 52 from a view of the direction of arrow B according to FIG. 7. As shown in FIG. 7, the backlight module 50 also comprises a plurality of lamp supports 55, each lamp support 55 having a substrate plate 551, a plurality of supporting holders 552, a plurality of engaging portions 554, and a plurality of protrusion components 556. Each supporting holder 552, disposed on the first side 5511 of the substrate plate 551, comprises a protecting ring 5522, on which an indentation 5521 forms. The light tube 58 may pass through the indentation 5521 for being fixed onto the protection circle 5522. A plurality of engaging portions 554 are disposed on the second side 5512, opposite to the first side 5511, of the substrate plate 551. In a preferred embodiment, the engaging portions 554, or, both the second side 5512 of the lamp support 55 and the engaging portions 554, are made of light proof materials. Comparatively, the substrate plate 551, the plurality of the supporting holders 552 and the protrusion components 556 are made of white reflective materials. A plurality of holes 522 are formed on the frame 52, and each engaging portion 554 is embedded into one of the holes 522 correspondingly. When the light guiding plate 56 and the diffusion plate 44 are fixed onto the groove 546 of the lamp holder 54, the region between the light guiding plate 56 and the diffusion place 44 may descend due to influence of gravity. In such case, the protrusion components 556 of the lamp support 55 are used for supporting the light guiding plate 56 and the diffusion plate 44 to be placed horizontally. The engaging portions 554 of the lamp support 55, being made of light proof materials, are embedded into the holes 522 of the frame 52. Therefore, the light generated by the light source 58, may be covered by the engaging portions 554 instead of emitting from the holes 522 of the frame 52, so as to reduce light leakage at back side of the backlight module.

By co-injection molding, the lamp holder 54 integrally shapes the light proof member 544 made of light proof materials and the light reflective component 541 made of white reflective materials. In a similar manner, the lamp support 55 may also integrally shapes the engaging portions 554 made of light proof materials, and the substrate plate 551, a plurality of supporting holders 552 and protrusion components 556 made of white reflective materials.

The backlight module 50 may be applied to a liquid crystal display.

In contrast to the prior art, the lamp holder according to the present invention utilizes a light proof component made of light proof materials and a light reflective component made of white reflective materials. Preferably, the light proof member is black, thereby covering the light scattered from the background light so as to reduce light leakage at edge sides of the backlight module. On the other hand, the lamp support according to the present invention utilizes, the engaging portions made of light proof materials, and the panel, a plurality of supporting holders and protrusion components made of white reflective materials. When the engaging portions of the lamp support are embedded into the holes of frame, the light generated by light source, may be covered by the engaging portions of light proof materials instead of emitting from the holes of frame, so as to reduce light leakage at back side of the backlight module.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A backlight module, comprising:
a frame having a plurality of holes defined on a bottom surface of the frame;
a plurality of light tubes, disposed on the frame, for generating light;
an optical sheet;
a first light tube fixing component, disposed on a side of the frame, for fixing the plurality of light tubes on the frame, the first light tube fixing component comprising:
a light proof member for blocking light from the plurality of light tubes; and
a light reflective component for reflecting light from the plurality of light tubes toward the optical sheet, wherein the light proof member and the light reflective component are integrally formed; and
a second light tube fixing component disposed on a bottom surface of the frame, comprising:
a substrate plate;
a plurality of supporting holders, disposed on a first side of the substrate plate, for fixing the plurality of light tubes; and
a plurality of engaging portions disposed on a second side opposite to the first side, each engaging portion being made of light proof materials and corresponding to a hole of the plurality of holes, wherein the substrate plate, the plurality of supporting holders, and the plurality of engaging portions are integrally formed.

2. The backlight module of claim 1, wherein the light proof member and the light reflective component of the first light tube fixing component are integrally formed by co-injection molding.

3. The backlight module of claim 1, wherein one of the plurality of supporting holders comprises a protection ring, and one of the plurality of light tubes is engaged with the protection ring so that the light tube is fixed on the supporting holder.

4. The backlight module of claim 1, wherein the second light tube fixing component further comprises a protrusion component, disposed on the first side of the substrate plate, for supporting the optical sheet.

5. The backlight module of claim 1, wherein the substrate plate, the plurality of supporting holders, and the plurality of engaging portions are integrally formed by co-injection molding.

6. The backlight module of claim 1, wherein the optical sheet is selected from the group consisting of a diffusion plate, a prism sheet, and a polarizing film.

7. A liquid crystal display device incorporating the backlight module of claim 1.

8. A backlight module comprising:
a frame;
a plurality of light tubes for generating light;
an optical sheet; and
a lamp holder, disposed on a side of the frame, for fixing the plurality of light tubes on the frame, the lamp holder comprising:
a light reflective component defining a plurality of indentations, the plurality of indentations to fix the plurality of light tubes, the light reflective component reflecting light from the plurality of light tubes toward the optical sheet; and
a light proof member, wherein the optical sheet is embedded with a groove formed between the light proof member and the light reflective component,
wherein the light proof member and the light reflective component are integrally formed.

9. The backlight module of claim 8, wherein the light proof member and the light reflective component are integrally formed by co-injection molding.

10. The backlight module of claim 8, wherein the optical sheet is selected from the group consisting of a diffusion plate, a prism sheet and a polarizing film.

11. The backlight module of claim 8, wherein the light proof member comprises a first opening, the light reflective component comprises a first slot, and a fixed component is fixed into the first slot of the light reflective component after passing through the first opening formed on the light proof member, so that the light proof member is fixed on the light reflective component.

12. The backlight module of claim 8, wherein the light proof member comprises a protrusion pillar, the light reflective component comprises a second slot, and the protrusion pillar is fixed into the second slot of the light reflective component so that the light proof member is fixed on the light reflective component.

13. The backlight module of claim 8, wherein the light proof member comprises a second opening, the light reflective component comprises a hook, and the hook passes through the second opening of the light proof member and is hooked with the light proof member, so that the light proof member is fixed on the light reflective component.

14. A liquid crystal display device incorporating the backlight module of claim 8.

15. A backlight module comprising:
a frame having a plurality of holes;
a plurality of light tubes for generating light;
an optical sheet; and
a lamp support disposed on a bottom surface of the frame, comprising:
a substrate plate;
a plurality of supporting holders, disposed on a first side of the substrate plate, for fixing the plurality of light tubes; and
a plurality of engaging portions disposed on a second side opposite to the first side, each engaging portion being made of light proof materials and corresponding to one of the plurality of holes,
wherein the substrate plate, the plurality of supporting holders, and the plurality of engaging portions are integrally formed.

16. The backlight module of claim 15, wherein one of the plurality of supporting holder comprises a protection ring, and one of the plurality of light tubes is engaged with the protection ring so that the light tube is fixed on the supporting holder.

17. The backlight module of claim 15, wherein the lamp holder further comprises a protrusion component, disposed on the first side of the substrate plate, for supporting the optical sheet.

18. The backlight module of claim 15, wherein the substrate plate, the plurality of supporting holders, and the plurality of engaging portions are integrally formed by co-injection molding.

19. The backlight module of claim 15, wherein the optical sheet is selected from the group consisting of a diffusion plate, a prism sheet and a polarizing film.

20. A liquid crystal display device incorporating the backlight module of claim 15.
